(19) United States
(12) Patent Application Publication
(10) Pub. No.: US 2013/0318252 A1
(43) Pub. Date: Nov. 28, 2013

(54) SYSTEMS, METHODS, AND COMPUTER PRODUCTS FOR ELEMENTARY STREAMS BROADCASTING

(71) Applicant: Yuri Bulava, Tomsk City (RU)

(72) Inventor: Yuri Bulava, Tomsk City (RU)

(73) Assignee: Rovi Corporation, Santa Clara, CA (US)

(21) Appl. No.: 13/480,181

(22) Filed: May 24, 2012

(51) Int. Cl. G06F 15/16

(52) U.S. Cl. 709/231

(57) ABSTRACT

The systems, methods, and computer program products described herein provide for the streaming data from a server to a client without the use of a container. The server receives, from the client, a request for data. In response, the server prepares and sends metadata to the client describing the requested data. The server then wraps one or more frames of the requested data for transmission to the client. In an embodiment, the wrapping process includes the appending of header data to the one or more frames. The header data includes a frame size field, a stream identifier field, and a presentation timestamp (PTS) field.

### BACKGROUND

Current computing and communications systems are often used for the transmission and receipt of multimedia information, including video and audio data. To enable such data transfers, the hypertext transfer protocol (HTTP) may be used. Existing HTTP streaming protocols provide for progressive downloads of such data. Using this mechanism, multiplexed data or a single elementary stream may be transferred.

Such a system includes a number of drawbacks. For example, data overhead may be significant. This is due, in part, to the use of a container or other metafile that specifies how data elements and metadata are formatted. The use of a container requires bandwidth, which in turn reduces throughput in a channel. The use of a container also increases storage requirements at a client.

What is needed, therefore, is a system that provides for the transmission of multimedia data from a server to a client using less bandwidth and requiring less storage at the client.

### BRIEF DESCRIPTION OF THE DRAWINGS/FIGURES

FIG. 1 is a block diagram illustrating interaction between a client and server to initiate streaming, according to an embodiment.

FIG. 2 is a flowchart illustrating interaction between a client and server to initiate streaming, according to an embodiment.

FIG. 3 is a flowchart illustrating processing at a client to initiate streaming, according to an embodiment.

FIG. 4 is a flowchart illustrating construction of a client request, according to an embodiment.

FIG. 5 is a flowchart illustrating processing at a server to initiate streaming, according to an embodiment.

FIG. 6 illustrates headers appended to requested data, according to an embodiment.

FIG. 7 is a block diagram illustrating interaction between a client and server during adaptive streaming, according to an embodiment.

FIG. 8 is a flowchart illustrating interaction between a client and server to initiate adaptive streaming, according to an embodiment.

FIG. 9 is a flowchart illustrating processing at a client to initiate adaptive streaming, according to an embodiment.

FIG. 10 is a flowchart illustrating construction of a client request for adaptive streaming, according to an embodiment.

FIG. 11 is a flowchart illustrating processing at a server to initiate adaptive streaming, according to an embodiment.

FIG. 12 is a block diagram illustrating interaction between a client and server during a seeking operation, according to an embodiment.

FIG. 13 is a flowchart illustrating interaction between a client and server to initiate a seeking operation, according to an embodiment.

FIG. 14 is a flowchart illustrating processing at a client to initiate a seeking operation, according to an embodiment.

FIG. 15 is a flowchart illustrating construction of a client request for a seeking operation, according to an embodiment.

FIG. 16 is a flowchart illustrating processing at a server to initiate a seeking operation, according to an embodiment.

FIG. 17 is a block diagram illustrating a computing system incorporated in a server, according to an embodiment.

In the drawings, the leftmost digit(s) of a reference number identifies the drawing in which the reference number first appears.

### DETAILED DESCRIPTION

An embodiment is now described with reference to the figures, where like reference numbers indicate identical or functionally similar elements. While specific configurations and arrangements are discussed, it should be understood that this is done for illustrative purposes only. A person skilled in the relevant art will recognize that other configurations and arrangements can be used without departing from the spirit and scope of the description. It will be apparent to a person skilled in the relevant art that this can also be employed in a variety of other systems and applications other than what is described herein.

The systems, methods, and computer program products described herein provide for the streaming data from a server to a client without the use of a container. The server receives, from the client, a request for data. In response, the server prepares and sends metadata to the client describing the requested data. The server then wraps one or more frames of the requested data for transmission to the client. In an embodiment, the wrapping process includes the appending of header data to the one or more frames. The header data includes a frame size field, a stream identifier field, and a presentation timestamp (PTS) field.

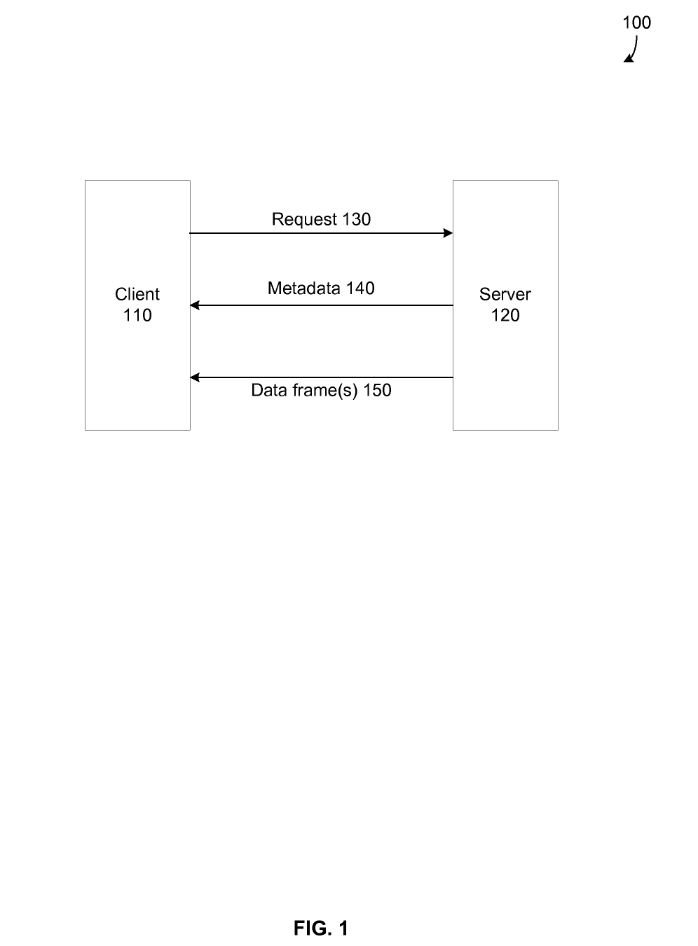

FIG. 1 illustrates the interaction between a client and a server, according to an embodiment. A client 110 is in communication with a server 120. In an embodiment, the client and server communicate using a version of the HTTP protocol. The client 110 sends a request 130 to server 120, requesting data. In an embodiment, the requested data may be multimedia data, e.g., video and/or audio data. This may take the form of a GET message in the context of HTTP. The server 120 responds by sending metadata 140 to the client 110. In an embodiment, the metadata 140 describes the data that will ultimately be sent to the client 110. The metadata 140 may describe the formatting of the data, for example, and may include an identifier for the current session. The server 120 may then send the requested data in one or more frames 150. Note that no container metafile is used in the illustrated transaction. As would be understood by a person of ordinary skill in the art, communications between the client 110 and server 120 may pass through one or more data networks (not shown).

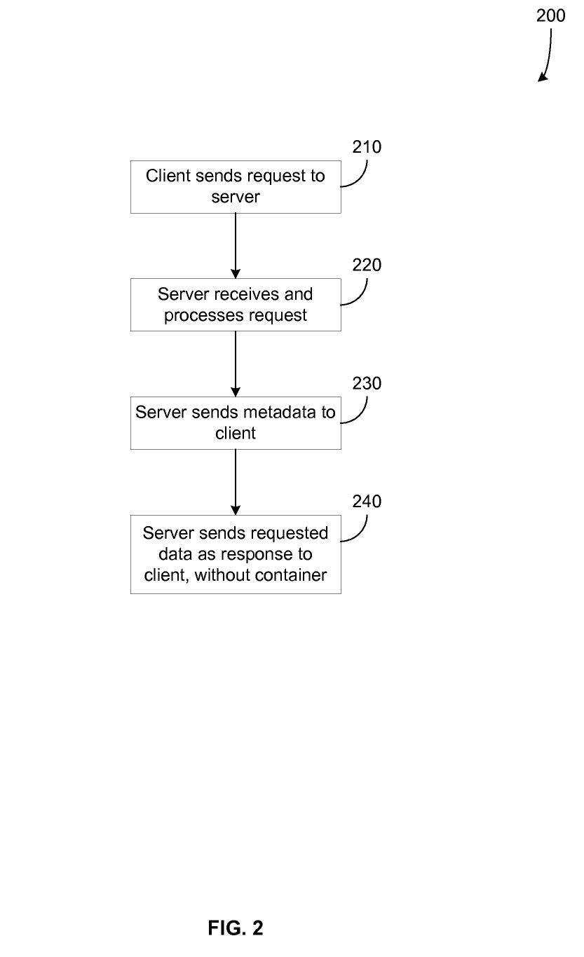

The interaction between the client and server is illustrated as a process flowchart in FIG. 2, according to an embodiment. At 210, the client sends a request for data to the server. At 220, the server receives and processes the request. The processing includes parsing of the request, including any headers in the request, to determine the specific data requested and any associated parameters. At 230, metadata is sent from the server to the client, where the metadata describes the data that will eventually be sent to the client. At 240, the requested data is sent to the client in the form of one or more frames. As will be described in greater detail below, the transmitted data will include headers affixed to the frame(s), describing parameters of the transmitted data and providing other information. As noted above, no container is used in the transmission of the requested data.

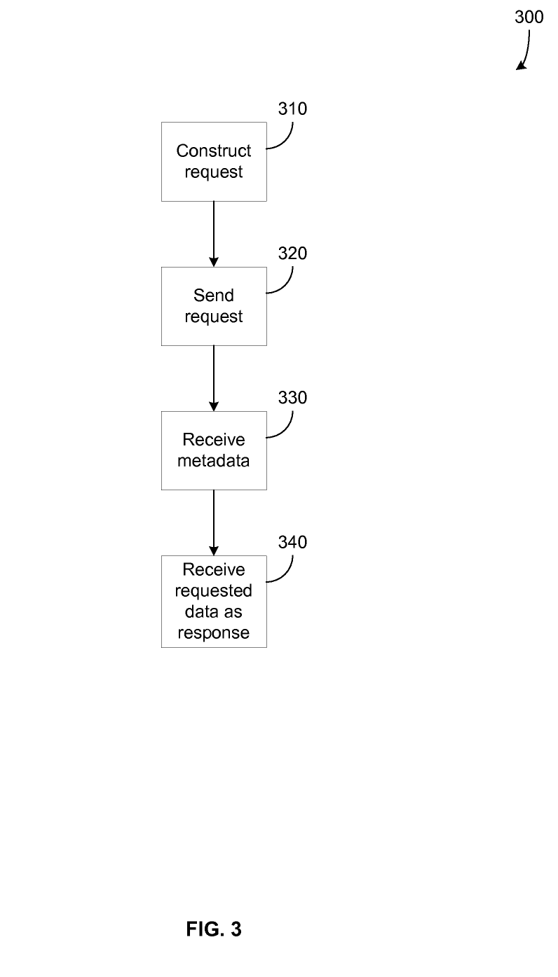

Processing at the client is illustrated in FIG. 3, according to an embodiment. At 310, the client constructs a request message for requesting data from the server. As will be described in greater detail below, the request may incorporate information about the requested data in the form of message headers. At 320, the request is sent from the client to the server. At 330, the client receives metadata from the server, describing the requested data. At 340, the requested data is received by the client as a response.

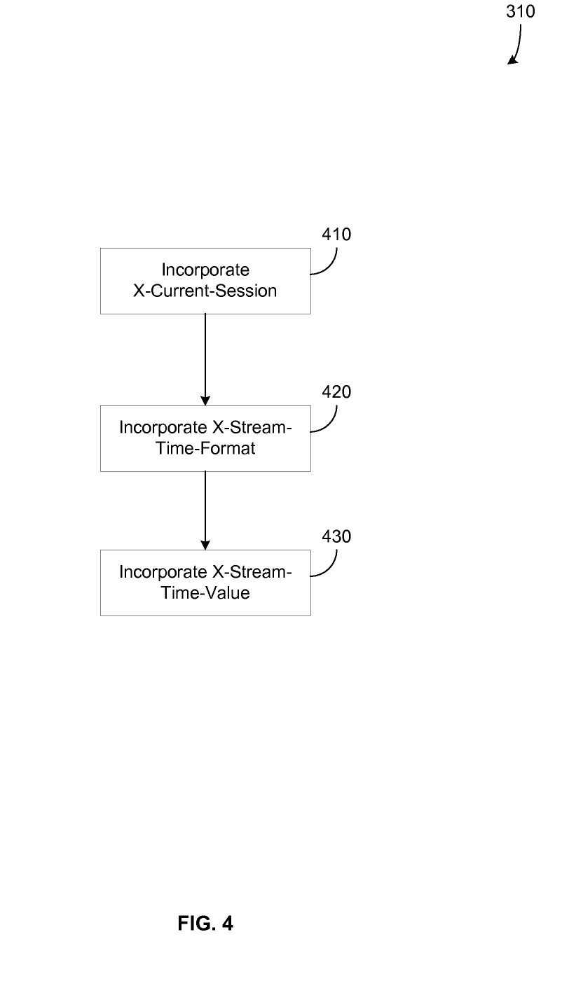

In an embodiment, the construction of the request message at the client (310 of FIG. 3) includes the processing illustrated in FIG. 4. At 410, a parameter identifying the session may be incorporated. This is denoted as X-Current-Session. At 420, a time format is specified as X-Stream-Time-Format. This format may be a Unix time format, or a network time protocol (ntp) format, for example. At 430, start and stop times for the data may be specified, in the case where the data represents audio and/or video. The start and stop times are collectively illustrated as the parameter X-Stream-Time-Value. In an embodiment, the parameters illustrated at 410-130 are incorporated in the request message as headers, where the request takes the form of a GET message in the context of HTTP.

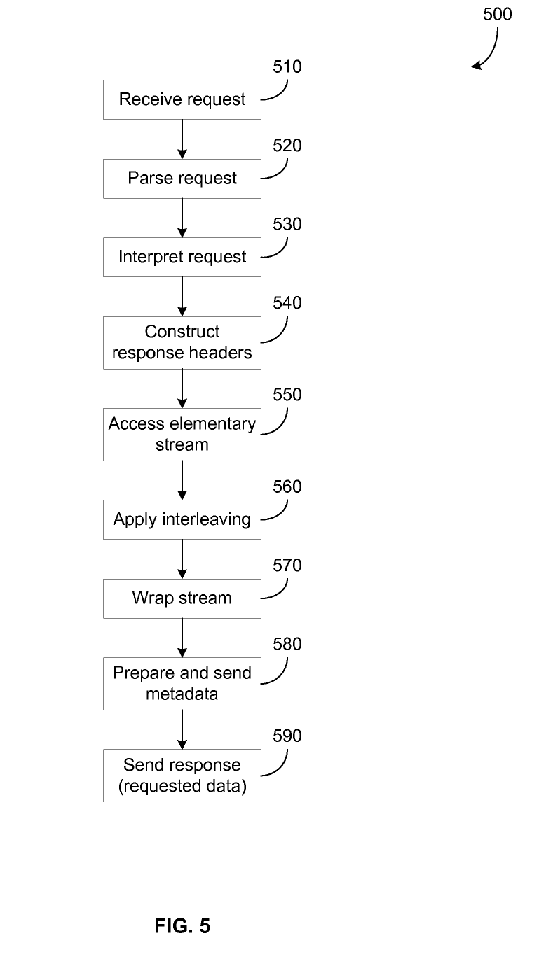

Processing at the server is illustrated in FIG. 5, according to an embodiment. At 510, the server receives a request for data, originated by the client. At 520, the server parses the request. This includes the identification of the various headers in the request. At 530, the server interprets the request to identify the data being requested and the related parameters. This interpretation may take the form of reading the headers that are included in the request as described above.

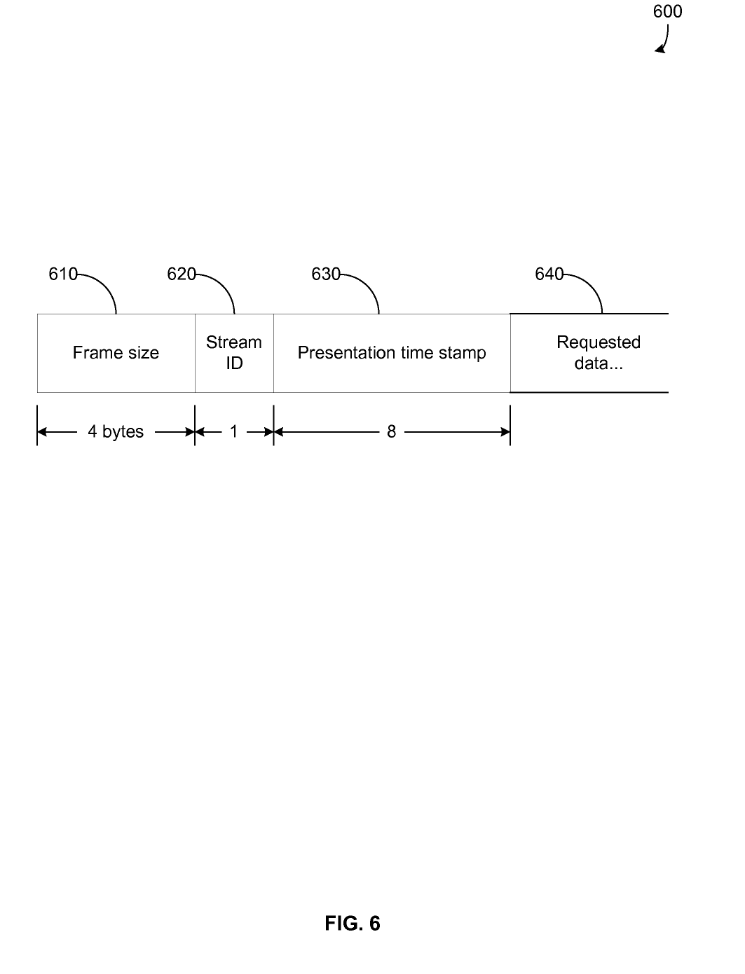

The server may then begin preparation of a response. At 540, headers for the response may be constructed. Example headers for a response will be described in greater detail below with respect to FIG. 6. At 550, and elementary stream containing the requested data is accessed. At 560, interleaving of different media types may be performed if required. For example, the data requested by the client may include both audio and video data. Here, segments of audio will be interleaved with segments of video. In an embodiment, if subtitles are necessary, this information will also be interleaved with the audio and video data. If it is necessary to observe a multimedia format standard, the size of the segments may be limited. For example, in order to adhere to the MPEG-2 standard, interleaving is limited to 0.7 seconds.

At 570, requested data is wrapped by attaching the headers constructed at 540 to the requested data. At 580, metadata related to the requested data is prepared and sent to the client. The metadata includes media identification information and stream type, e.g., “media 0, AVC”, or “media 1, AAC”. In an embodiment, the metadata may also include codec configuration information for use of the client, to facilitate client initialization. The metadata may also include other stream qualities associated with the session. The format of the metadata is specified in a header of the metadata message. The metadata may be formatted in any of several ways. For example, the metadata may be formatted according to the Session Description Protocol (SDP). Alternatively, the metadata may be formatted using Extensible Mark-up Language/Synchronized Multimedia Integration Language (XML/SMIL) descriptors.

At 590, the response is sent to the client, including the wrapped requested data in the form of one or more frames.

An example frame is illustrated in FIG. 6, according to an embodiment. The illustrated frame 600 includes headers 610 through 630, constructed by the server at 540 above. A header 610 specifies the size of the frame. In an embodiment, the specified frame size excludes the headers 610 through 630. Header 620 identifies the particular stream. Header 630 represents a presentation timestamp (PTS). This header specifies a point in time at which multiple media types (e.g., audio, video, and subtitles) in the requested data may begin, and allows for the synchronization of the multiple media types. The headers are then followed by the requested data 640. In an embodiment, the frame size header 610 is represented in four bytes, the stream ID header 620 is represented in one byte, and the PTS header 630 is represented in eight bytes.

Given the data provided to the client through metadata 140 and headers 610 through 630, it is not necessary to provide a separate container metafile to the client. In an embodiment, this may permit a savings of 20 to 30% in data overhead.

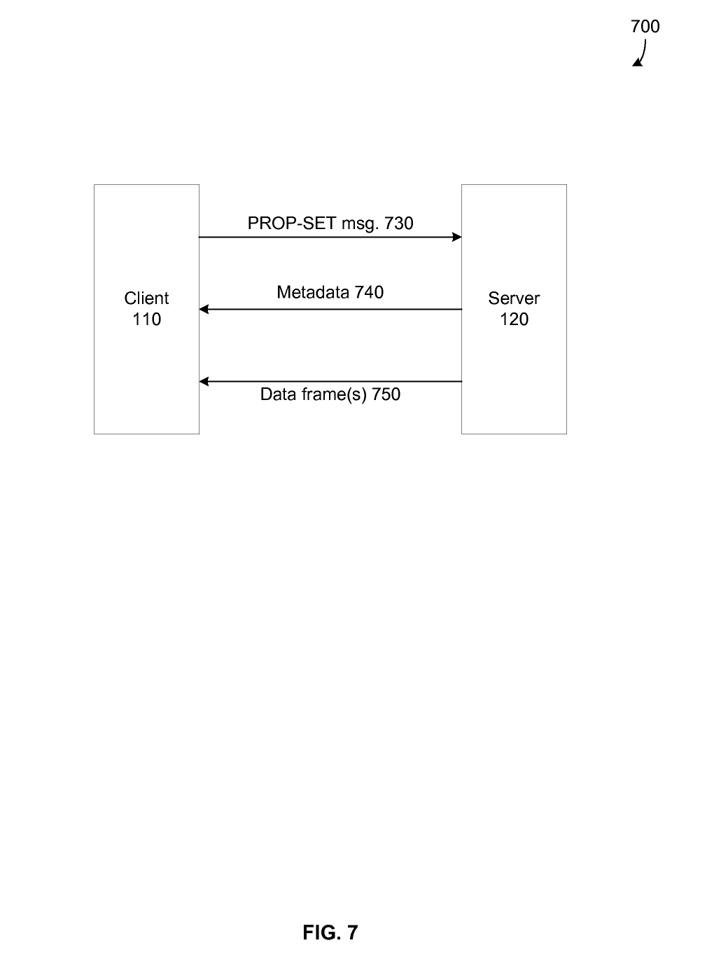

The system and processing described herein allow for adaptive streaming, where the client may request that changes be made in bit rate and in quality of the stream of requested data. The processing of such request is illustrated in FIG. 7. Here, the client 110 may send a message 730 to the server 120, requesting a change in properties of a stream. Such a message is referred to herein as a property setting (PROP-SET) message. The server 120 may then prepare and send metadata 740 to the client 110, where this metadata describes the requested data. Data frame(s) 750, bearing the requested data (i.e., the stream having the newly changed properties), are then sent by server 120 to client 110.

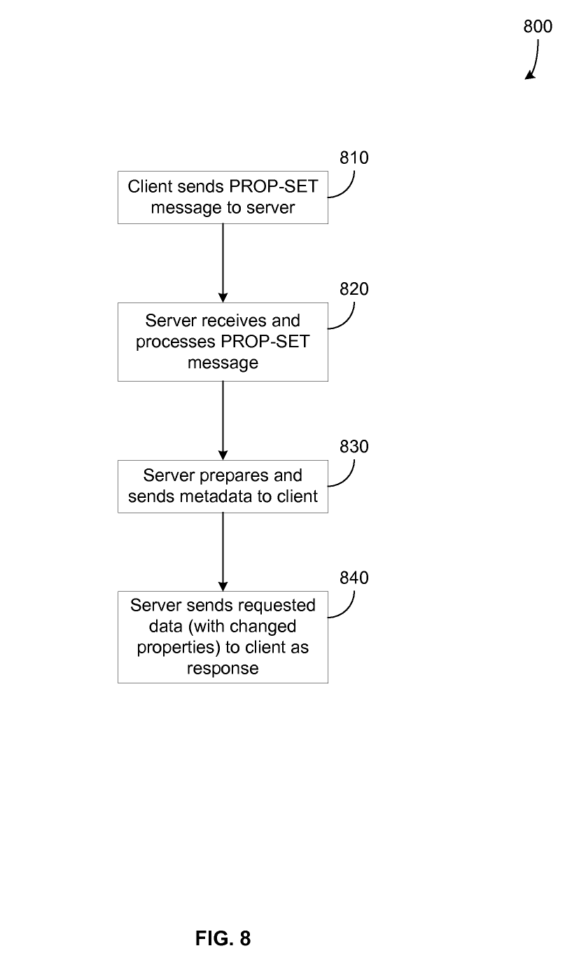

The client-server interaction used in adaptive streaming is illustrated in FIG. 8, according to an embodiment. At 810, a client sends a PROP-SET message to the server, to specify one or more changed properties, e.g., a different quality level, desired in a stream of requested data. At 820, the server receives the PROP-SET message. At 830, the server prepares and sends metadata to the client, where the metadata describes properties of the requested data. At 840, the server sends the requested data to the client, where the data has the changed properties.

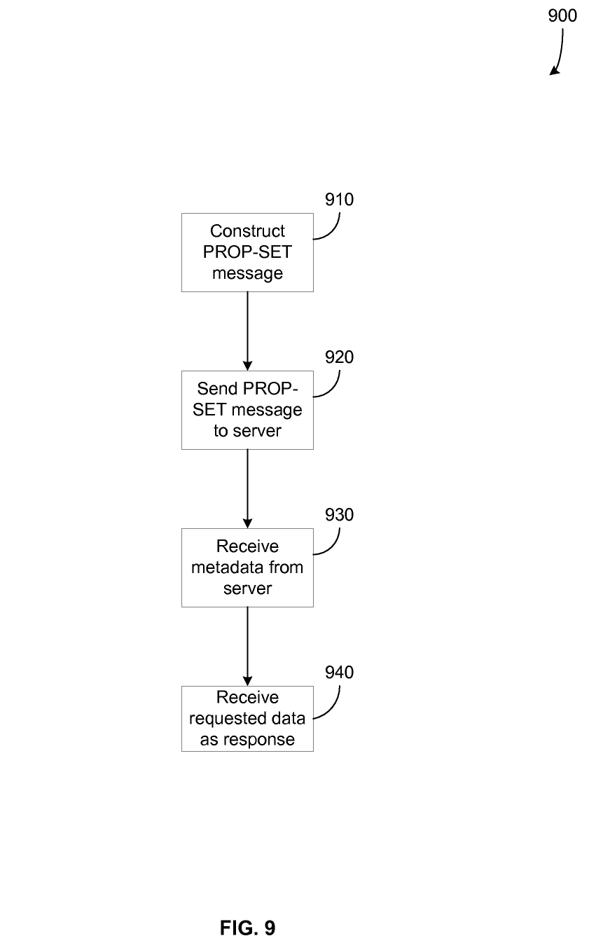

Processing at the client for adaptive streaming is described in FIG. 9, according to an embodiment. At 910, the client may construct a PROP-SET message. The construction of this message will be described in greater detail below. At 920, the PROP-SET message is sent to the server. At 930, metadata is received from the server. The metadata describes the requested data to be received from the server. At 940, the stream of requested data is received by the client, where the stream has properties defined in the PROP-SET message.

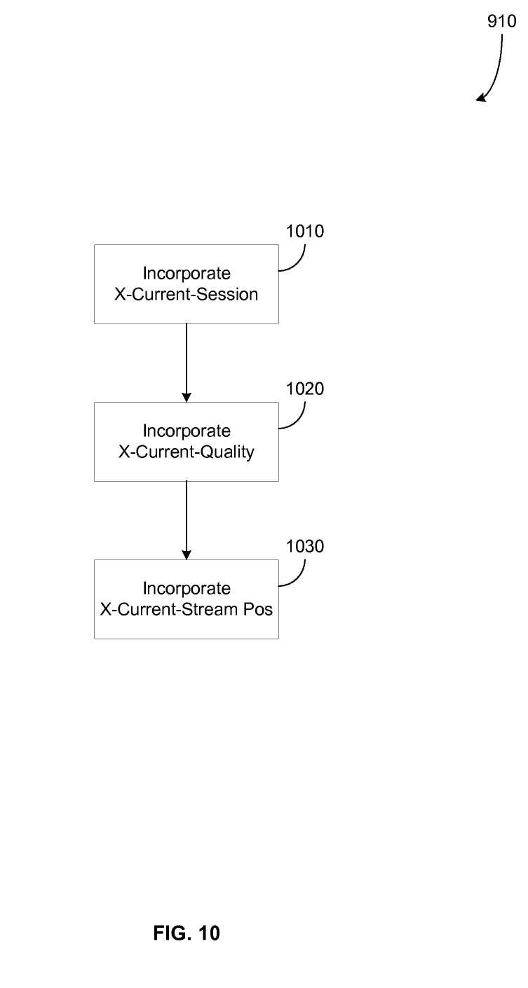

The construction of the PROP-SET message at 910 may include the incorporation of several parameters relating to the requested data. This is illustrated in FIG. 10, according to an embodiment. At 1010, an identifier of the current session is incorporated into the message. This identifier is specified in a header, and shown here as the parameter X-Current-Session. At 1020, a desired quality level for the stream of requested data is specified. Again, this may take the form of a header in the PROP-SET message. The quality level is shown here as the parameter X-Current-Quality. At 1030, the point in the stream at which the changed quality is to take effect is incorporated in the PROP-SET message. This point is specified in a header, as the parameter X-Current-Stream-Pos.

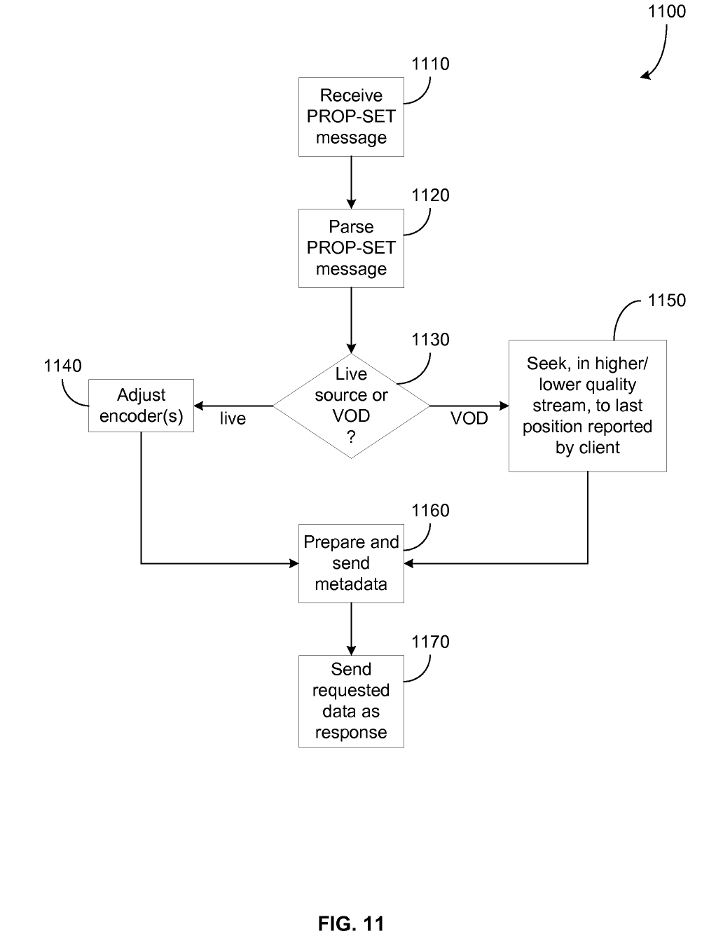

Processing of an adaptive streaming request by the server is illustrated in FIG. 11, according to an embodiment. At 1110, the server receives the PROP-SET message from the client. At 1120, this message is parsed to locate the assorted parameters discussed with respect to FIG. 9. At 1130, in the case of a multimedia stream, a determination is made as to whether the source of the current stream is live or “video on demand” (VOD). If the stream is from a live source, then at 1140, adjustments may be made to accommodate the property changes specified in the PROP-SET message. Where a change in the quality of the stream is requested, these adjustments may include a change in operating parameters of one or more video and/or audio encoders to achieve a higher or lower quality, depending on the properties specified in the PROP-SET message. In an embodiment, this change in the encoding will start at the last position in the current stream reported by the client. If the multimedia stream is VOD, then at 1150, a seek operation is performed in a higher or lower quality version of the current stream (depending on whether the PROP-SET message specified a higher or lower quality). The seek operation goes to the last position reported by the client.

At 1160, metadata is prepared and sent to the client, where the metadata describes the requested data. The metadata includes media identification information and stream type, e.g., “media 0, AVC”, or “media 1, AAC”. In an embodiment, the metadata may also include codec configuration information for use of the client, to facilitate client initialization. The metadata may also include other stream qualities associated with the session. The format of the metadata is specified in a header of the metadata message. The metadata may be formatted in any of several ways, e.g., according to the SDP or using XML/SMIL descriptors.

At 1170, the requested data, i.e., the stream with properties modified according to the PROP-SET message, is sent to the client in the form of a response. As before, a container is not used in the sending of the requested data.

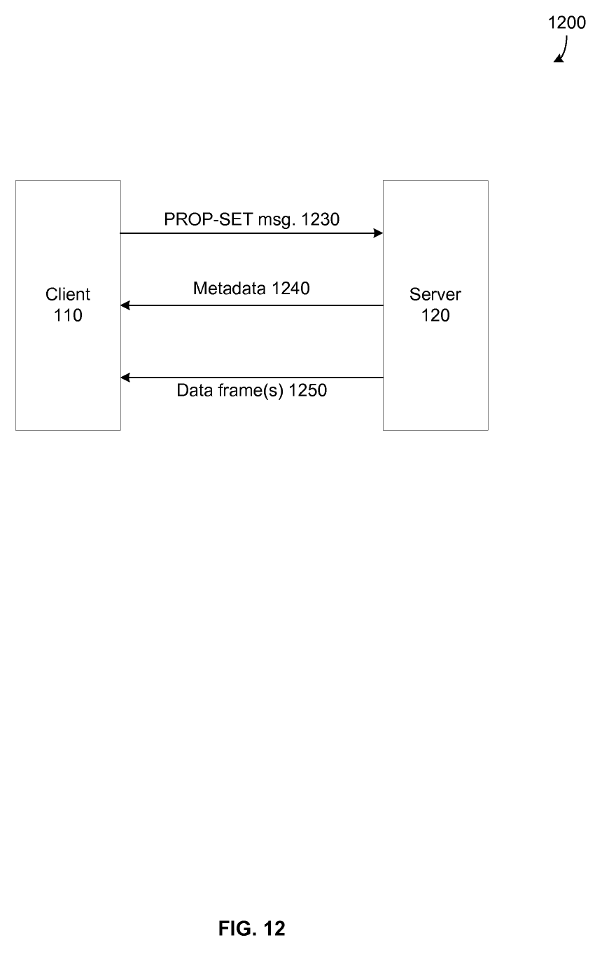

The system and processing described herein allow for a seeking operation, where the client may request that the server jump to a particular point in a stream. The processing of such request is illustrated in FIG. 12, according to an embodiment. Here, the client 110 may send a message 1230 to the server 120, requesting that the stream be delivered starting at a particular point. This message may take the form of a PROP-SET message. The server 120 may then prepare and send metadata 1240 to the client 110, where this metadata describes the requested data. Data frame(s) 1250, bearing the requested data (i.e., the stream, starting at the designated point), are then sent by server 120 to client 110.

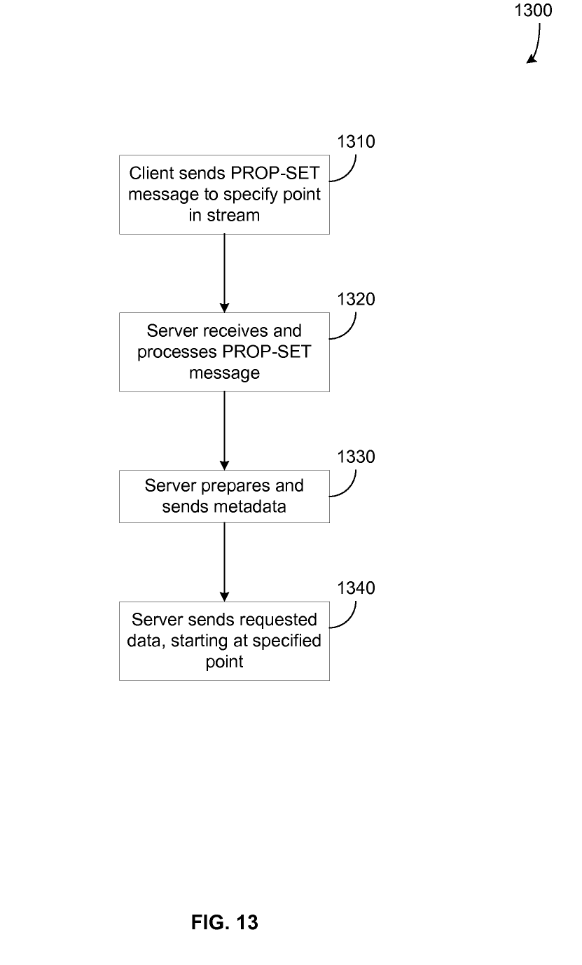

The client-server interaction used in seeking is illustrated in FIG. 13, according to an embodiment. At 1310, the client sends a PROP-SET message to the server, specifying a particular point in the stream. This may be viewed as a request by the client to seek to this point in the stream. At 1320, the server receives and processes this message. At 1330, the server prepares and sends metadata to the client, where the metadata describes the requested data to be sent. At 1340, the server sends the requested data to the client, starting at the designated point in the stream.

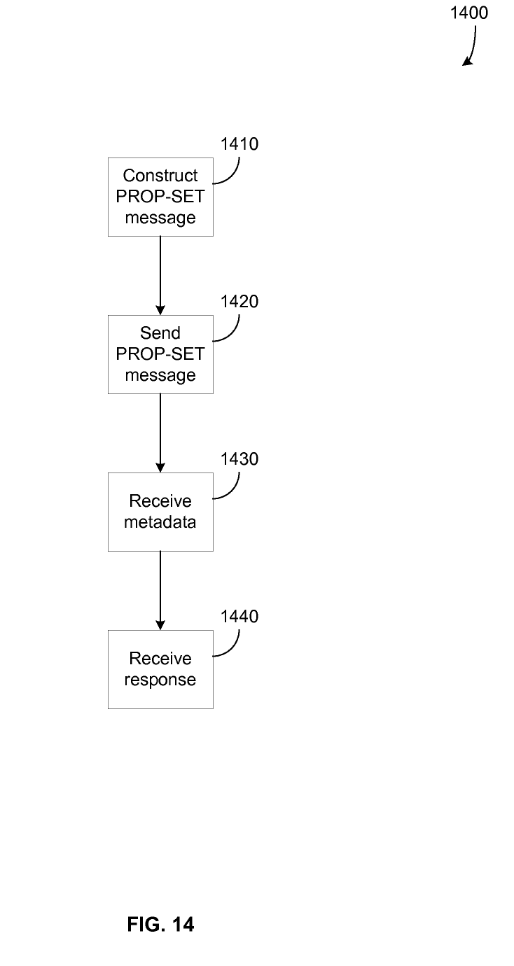

Processing at the client in this context is illustrated in FIG. 14, according to an embodiment. At 1410, the client constructs the PROP-SET message, designating a particular point in the stream. At 1420, this message is sent to the server. At 1430, metadata is received from the server, where this metadata describes properties of the requested data. At 1440, the requested data is received as a response from the server.

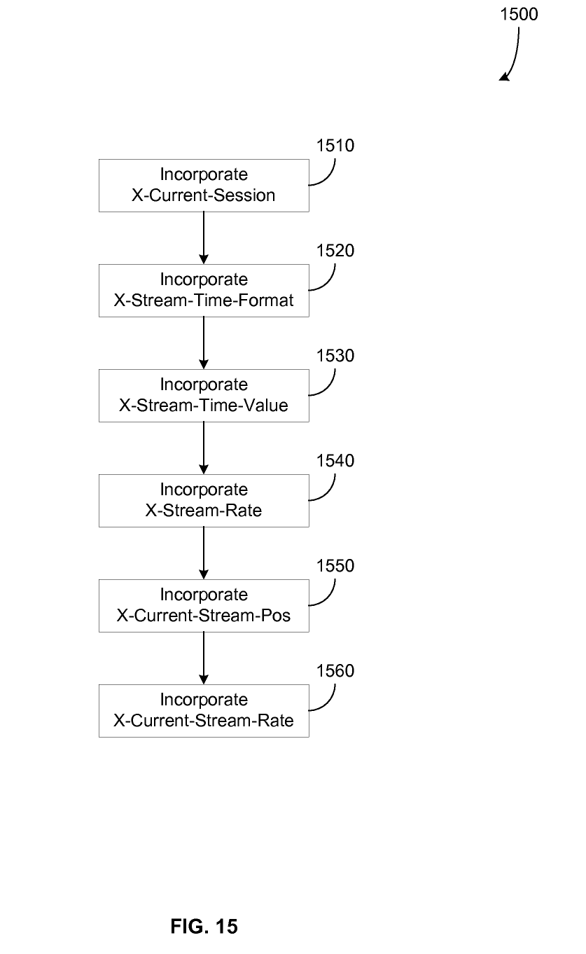

The construction of the PROP-SET message at the client includes the incorporation of particular parameters relating to the stream. In an embodiment in which the client and server communicate using HTTP, these parameters may be incorporated in the form of headers. Such an embodiment is illustrated in FIG. 15. At 1510, an identifier for the session, X-Current-Session, is incorporated into the PROP-SET message, in the form a header. At 1520, a particular time format is incorporated into the message as the parameter X-Stream-Time-Format. Again, this parameter is incorporated into the PROP-SET message in the form of the header. At 1530, a time value is incorporated into the message as a header. This value is shown here as the parameter X-Stream-Time-Value. At 1540, a streaming rate is incorporated as a header into the PROP-SET message as the parameter X-Stream-Rate. At 1550, the desired position in the stream is specified in a header as the parameter X-Current-Stream-Rate. At 1560, a desired rate of the current stream is incorporated in the header as the parameter X-Current-Stream-Rate.

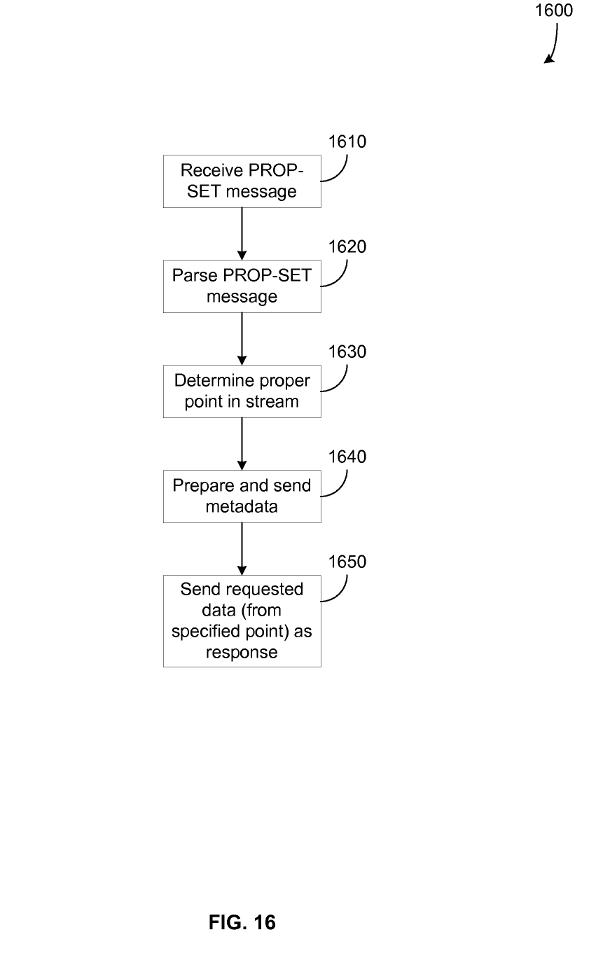

The server's processing of the client's request to seek is illustrated in FIG. 16. At 1610, the server receives the PROP-SET message sent by the client. At 1620, the server parses this message. In so doing, the server locates the headers in the PROP-SET message discussed above. In 1630, the server determines the proper point in the stream, as specified by this message. At 1640, the server prepares and sends metadata to the client, where this metadata describes the requested data, i.e., the stream as it will be sent beginning at the designated point. The metadata includes media identification information and stream type, e.g., “media 0, AVC”, or “media 1, AAC”. In an embodiment, the metadata may also include codec configuration information for use of the client, to facilitate client initialization. The metadata may also include other stream qualities associated with the session. The format of the metadata is specified in a header of the metadata message. The metadata may be formatted in any of several ways, e.g., according to the SDP or using XML/SMIL descriptors. At 1650, the requested data is sent as a response to the client.

Methods and systems are disclosed herein with the aid of functional building blocks illustrating the functions, features, and relationships thereof. At least some of the boundaries of these functional building blocks have been arbitrarily defined herein for the convenience of the description. Alternate boundaries may be defined so long as the specified functions and relationships thereof are appropriately performed.

One or more features disclosed herein may be implemented in hardware, software, firmware, and combinations thereof, including discrete and integrated circuit logic, application specific integrated circuit (ASIC) logic, and microcontrollers, and may be implemented as part of a domain-specific integrated circuit package, or a combination of integrated circuit packages. The term software, as used herein, refers to a computer program product including at least one computer readable medium having computer program logic stored therein to cause a computer system to perform one or more features and/or combinations of features disclosed herein. The computer readable medium may be transitory or non-transitory. An example of a transitory computer readable medium may be a digital signal transmitted over a radio frequency or over an electrical conductor, through a local or wide area network, or through a network such as the Internet. An example of a non-transitory computer readable medium may be a compact disk, a flash memory, or other data storage device.

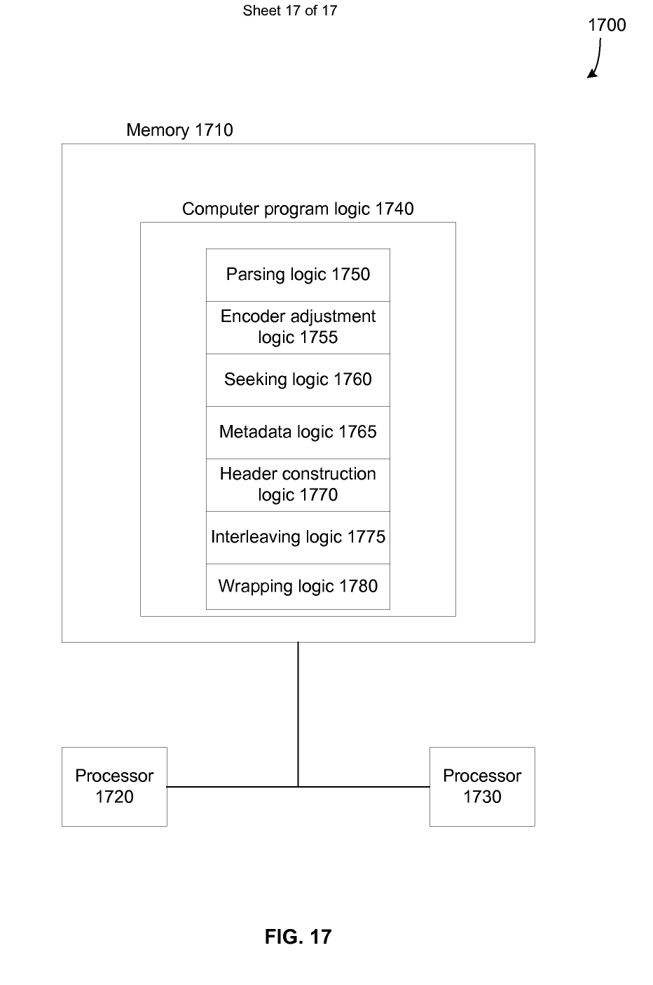

A server that performs the processing described above may incorporate a programmable computing system. Such a computing system executes software/firmware embodying the above processing. Such a system is shown in FIG. 17, according to an embodiment. The illustrated system 1700 may include one or more processor(s) 1720 and may further include a body of memory 1710. Processor(s) 1720 may include one or more central processing unit cores. Memory 1710 may include one or more computer readable media that may store computer program logic 1740. Memory 1710 may be implemented as a hard disk and drive, a removable media such as a compact disk, a read-only memory (ROM) or random access memory (RAM) device, for example, or some combination thereof. Processor(s) 1720 and memory 1710 may be in communication using any of several technologies known to one of ordinary skill in the art, such as a bus or point-to-point interconnect. Computer program logic 1740 contained in memory 1710 may be read and executed by processor(s) 1720. One or more I/O ports and/or I/O devices, shown collectively as I/O 1730, may also be connected to processor(s) 1720 and memory 1710. In an embodiment, one or more I/O devices 1730 are used to receive and/or send communications with a client.

Computing program logic 1750 may include parsing logic 1750, which is responsible for parsing messages from a client, such as GET and PROP-SET messages. This allows the server to locate and read the parameters contained in these messages. These parameters may include, for example, a session identifier, a time value and time format, and any quality parameters, stream positions, and stream rates. Computing program logic 1750 may also include encoder adjustment logic 1755, which may be responsible for making adjustments to the operation of one or more video and/or audio encoders in order to accommodate any changes requested by the client with respect to quality or stream rate. Computing program logic 1750 may also include seeking logic 1760, which may be responsible for finding a point in a stream specified in a PROP-SET message from a client.

Computing program logic 1750 may also include metadata logic 1765, which is responsible for constructing the metadata that is sent from the server to the client in advance of the response. Computing program logic 1750 may also include header construction logic 1765, responsible for creating the headers for the requested data as illustrated in FIG. 6. Computing program logic 1750 may also include interleaving logic 1775, which is responsible for interleaving audio, video, and/or subtitle information in a stream to be served to the client. Computing program logic 1750 may also include wrapping logic 1780, which is responsible for appending the headers constructed by header construction logic 1770 to the requested data and otherwise formatting the resulting frame(s).

Note that the above logic modules represent an embodiment of a software or firmware implementation of the processing described herein. In alternative embodiments, one or more of these logic modules may be combined with another; moreover, one or more may be absent in other embodiments.

While various embodiments are disclosed herein, it should be understood that they have been presented by way of example only, and not limitation. It will be apparent to persons skilled in the relevant art that various changes in form and detail may be made therein without departing from the spirit and scope of the methods and systems disclosed herein. Thus, the breadth and scope of the claims should not be limited by any of the exemplary embodiments disclosed herein.

What is claimed is:

1. A method for streaming data, comprising:
receiving, from a client, a request for data;
sending metadata to the client, describing the requested data;
creating a frame that comprises the requested data and headers appended to the requested data; and
sending a first response to the client without a container, wherein the first response comprises the frame.

2. The method of claim 1, wherein said data comprises one or more of video data and audio data.

3. The method of claim 2, further comprising:
interleaving the audio data and video data, performed prior to sending the first response to the client.

4. The method of claim 1, wherein communications with the client take place according to a version of the hypertext transfer protocol (HTTP).

5. The method of claim 1, wherein the first header comprises:
a frame size field;
a stream identifier field; and
a presentation timestamp (PTS) field.

6. The method of claim 1, further comprising:
receiving a property setting message from the client;
sending additional metadata to the client, describing new properties of the requested data, wherein the new properties are consistent with the property setting message;
creating an additional frame of the requested data having the new properties, the additional frame comprising the requested data having the new properties and a second header appended to the requested data having the new properties; and
sending a second response to the client without a container, wherein the second response comprises the additional frame.

7. The method of claim 6, further comprising:
adjusting one or more encoding parameters in accordance with the property setting message; and
encoding the requested data in accordance with the adjusted encoding parameters to create the requested data having the new properties,
performed before sending the second response.

8. The method of claim 7, wherein the property setting message comprises one or more of:
a header identifying a current session;
a header identifying a desired quality level of the requested data; and
a header identifying a current stream position.

9. The method of claim 1, further comprising:
receiving a property setting message from the client;
sending additional metadata to the client, describing properties of the requested data;
creating an additional frame of the requested data, the additional frame comprising requested data starting at a point specified in the property setting message, and further comprising a second header appended to the requested data that starts at the specified point; and
sending a second response to the client without a container, wherein the second response comprises the additional frame.

10. The method of claim 9, wherein the property setting message comprises one or more of:
a header identifying a current session;
a header identifying a time format;
a header identifying time values corresponding to the point in the requested data and to a stop time for outputting the requested data to a user;
a header identifying a desired stream rate;
a header identifying a current stream position; and
a header identifying a current stream rate.

11. The method of claim 1, wherein the request comprises:
a header identifying a current session;
a header identifying a time format; and
a header identifying time values indicating start and stop times for outputting the requested data to a user.

12. A server for streaming data, comprising:
a processor; and
a memory in communication with said processor, said memory for storing a plurality of processing instructions configured to direct said processor to
receive, from a client, a request for data;
send metadata to the client, describing the requested data;
create a frame that comprises the requested data and headers appended to the requested data; and
send a first response to the client without a container, wherein the first response comprises the frame.

13. The server of claim 12, wherein said data comprises one or more of video data and audio data.

14. The server of claim 13, wherein said plurality of processing instructions is further configured to direct said processor to:
interleave the audio data and video data, performed prior to sending the first response to the client.

15. The server of claim 12, wherein communications with the client take place according to a hypertext transfer protocol (HTTP).

16. The server of claim 12, wherein the first header comprises:
a frame size field;
a stream identifier field; and
a presentation timestamp (PTS) field.

17. The server of claim 12, wherein the plurality of processing instructions is further configured to direct said processor to:
receive a property setting message from the client;
send additional metadata to the client, describing the properties of the requested data, wherein the new properties are consistent with the property setting message;
create an additional frame of the requested data having the new properties, the additional frame comprising the requested data having the new properties and a second header appended to the requested data having the new properties; and
send a second response to the client without a container, wherein the second response comprises the additional frame.

18. The server of claim 17, wherein the plurality of processing instructions is further configured to direct said processor to:
adjust one or more encoding parameters in accordance with the property setting message; and
encode the requested data in accordance with the adjusted encoding parameters to create the requested data having the new properties,
performed before sending the second response.

19. The server of claim 18, wherein the property setting message comprises one or more of:
a header identifying a current session;
a header identifying a desired quality level of the requested data; and
a header identifying a current stream position.

20. The server of claim 12, wherein the plurality of processing instructions is further configured to direct said processor to:
receive a property setting message from the client;
send additional metadata to the client, describing properties of the requested data;
create an additional frame of the requested data, the additional frame comprising requested data starting at a point specified in the property setting message, and further comprising a second header appended to the requested data that starts at the specified point; and
send a second response to the client without a container, wherein the second response comprises the additional frame.

21. The server of claim 20, wherein the property setting message comprises one or more of:
a header identifying a current session;
a header identifying a time format;
a header identifying time values corresponding to the point in the requested data and to a stop time for outputting the requested data to a user;
a header identifying a desired stream rate;
a header identifying a current stream position; and
a header identifying a current stream rate.

22. The server of claim 12, wherein the request comprises:
a header identifying a current session;
a header identifying a time format; and
a header identifying time values indicating start and stop times for outputting the requested data to a user.

23. A computer program product comprising a non-transitory computer useable medium having control logic stored therein, the computer control logic comprising logic to cause a processor to perform the following:
receiving, from a client, a request for data;
sending metadata to the client, describing the requested data;
creating a frame that comprises the requested data and headers appended to the requested data; and
sending a first response to the client without a container, wherein the first response comprises the frame.

24. The computer program product of claim 23, wherein said data comprises one or more of video data and audio data.

25. The computer program product of claim 24, the computer control logic further comprising logic to cause a processor to perform the following:
interleaving the audio data and video data, performed prior to sending the first response to the client.

26. The computer program product of claim 23, wherein communications with the client take place according to a hypertext transfer protocol (HTTP).

27. The computer program product of claim 23, wherein the first header comprises:
a frame size field;
a stream identifier field; and
a presentation timestamp (PTS) field.

28. The computer program product of claim 23, the computer control logic further comprising logic to cause a processor to perform the following:
receiving a property setting message from the client;
sending additional metadata to the client, describing the properties of the requested data, wherein the new properties are consistent with the property setting message;
creating an additional frame of the requested data having the new properties, the additional frame comprising the requested data having the new properties and a second header appended to the requested data having the new properties; and
sending a second response to the client without a container, wherein the second response comprises the additional frame.

29. The computer program product of claim 28, the computer control logic further comprising logic to cause a processor to perform the following:
adjusting one or more encoding parameters in accordance with the property setting message; and
encoding the requested data in accordance with the adjusted encoding parameters to create the requested data having the new properties,
performed before sending the second response.

30. The computer program product of claim 29, wherein the property setting message comprises one or more of:
a header identifying a current session;
a header identifying a desired quality level of the requested data; and
a header identifying a current stream position.

31. The computer program product of claim 23, the computer control logic further comprising logic to cause a processor to perform the following:
receiving a property setting message from the client;
sending additional metadata to the client, describing properties of the requested data;
creating an additional frame of the requested data, the additional frame comprising requested data starting at a point specified in the property setting message, and further comprising a second header appended to the requested data that starts at the specified point; and
sending a second response to the client without a container, wherein the second response comprises the additional frame.

32. The computer program product of claim 31, wherein the property setting message comprises one or more of:
a header identifying a current session;
a header identifying a time format;
a header identifying time values corresponding to the point in the requested data and to a stop time for outputting the requested data to a user;
a header identifying a desired stream rate;
a header identifying a current stream position; and
a header identifying a current stream rate.

33. The computer program product of claim 23, wherein the request comprises:
a header identifying a current session;
a header identifying a time format; and
a header identifying time values indicating start and stop times for outputting the requested data to a user.
